(19) United States
(12) Patent Application Publication
(10) Pub. No.: US 2004/0066307 A1
(43) Pub. Date: Apr. 8, 2004

(54) Light-emitting device array

(76) Inventors: Ming-Der Lin, Hsinchu (TW); Jung-Kuei Hsu, Taipei (TW); Chih-Hsiung Shen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/653,984

(22) Filed: Sep. 4, 2003

(30) Foreign Application Priority Data
Sep. 4, 2002 (TW) 091120130

(51) Int. Cl. G08B 5/22

(52) U.S. Cl. 340/815.45

(57) ABSTRACT

A light-emitting device array is provided. The light-emitting diode array is with functions of accurately positioning and light-guiding provided by a plurality of light-outputting windows, comprising a plurality of light-outputting windows, regularly arranged and presented as taper mode as well, chiseled into a circuit board, at least one connecting line corresponding to each light-outputting window being provided on the circuit board. The light-emitting device array with a plurality of light-emitting devices may be mounted onto said circuit board, such that each light-emitting device is resided in the corresponding light-outputting window, and the electrode of each light-emitting device may be contacted with the corresponding connecting line, resulting in electrically connecting to a control IC. Two isolated layers, i.e., a contacting layer for first electrode and a contacting layer for second electrode, are provided on two opposite slanting side-walls of each light-outputting window, respectively, wherein the contacting layer for first electrode may be electrically connected to one control IC by means of one control line buried in the circuit board previously, while the contacting layer for second electrode may be electrically connected to the other control IC by means of the other control line. A light-emitting diode may be carried and held inside the light-outputting window. First and second electrodes of the light-emitting diode may be contacted and fixed to the corresponding contacting layers for electrodes naturally, such that the electrical connection could be accomplished without a wire-bonding process. This will result in a substantially reduced number of wire-bondings. Combined with the feature of precisely chiseling the light-outputting window, the precisely positioning between respective light-emitting device array devices may be accomplished readily, for reducing the interference effect among projecting lights. Thus, it is suitably applied for a high-density light-emitting diode array.

### FIELD OF THE INVENTION

The present invention is related to a light-emitting device array, particularly to a light-emitting device array with functions of accurately positioning and light-guiding provided by a plurality of light-outputting windows.

### BACKGROUND

Accordingly, the light-emitting device array (LED array), formed from a plurality of independent and regularly arranged LED units, is widely applied to fax machines, scanners, printers, printing machines, large screens, or display panels. The reasons of whether respective LEDs are regularly arranged, or whether emitted lights are interfered with each other, and so on, may have significant effect on the quality of luminescence, document printing, or image presentation.

For this reason, the industry invests a large amount of resource for developing a LED array with a better luminescence quality. For instance, as demonstrated in U.S. Pat. Nos. 6,236,065 and 6,191,438, entitled “LIGHT-EMITTING DIODE ARRAY AND METHOD FOR FABRIC ATING THE SAME” and “LIGHT-EMITTING DIODE ARRAY”, respectively, disclosed by Sharp Kabushiki Kaisha, both of them have proposed a structure or technology for improving the luminescence quality of the LED array.

As illustrated in FIGS. 1 and 2, there are shown a structural top view and a schematic perspective view of a conventional LED array, respectively. The LED array essentially comprises an luminescent active layer 14 for emitting light and a first electrode 19, provided on a surface of a LED substrate 11, respectively. An insulative layer 17 or a transversely and regularly arranged current diffusion layer 16 may be provided at appropriate sites on the active layer 14, respectively, by means of micro electro-mechanical technology such as etching, for example. The location where the current diffusion layer 16 resides is a predetermined luminescence zone. A second electrode 18 made from light-transmissive oxide material is used for directing the connecting line of the luminescence zone 16 toward a predetermined wire-bonding region 12 at relatively outlying side, and then electrically connected to a corresponding control IC (not shown) via a control line after the wire-bonding process is finished at this predetermined wire-bonding region, for avoiding the projecting light source, emitted from the luminescence zone 16, to be blocked by a bonding pad, and considering the facility for proceeding wire-bonding process. In addition, any two of LED array devices 101, 102 must bc regularly arranged for the purpose of responding practical usage and dimension requirement of products, such that the luminescence zones 16, 162 may be transversely and linearly arranged and may project linear light source for supplying products.

Fundamentally, in the structure of above conventional LED array, there must exist connecting lines, the number of which is identical to that of the LEDs, directed from LEDs. A wire-bonding joint approach is commonly used as leading process for the connecting lines. There are problems, however, with respect to this conventional wire-bonding approach as follows:

1. Difficulty in manufacture and expenditure cost may increase greatly, due to the increase in the number of wire-bondings and the reduction in the spacing 112 between wire-bonding arrays;

2. Other electrical lines will be liable to come off, caused by the wire-bonding operation for the connecting lines, corresponding reducing the yield rate of products, luminescence quality, or service life;

3. Cross-talk interference between two adjacent LEDs is induced, since except for B-type light source emitting from normal face, T-type light source emitting from lateral face is also included in the light source projected from the luminescence zone, and it is possible for these two-type light sources to project toward the surface of the adjacent LED to radiate, thus increasing the difficulty for identifying exact luminescent location and further degrading the resolution quality of image;

4. An spacing between arrays 112 exists between any two of the LED array devices 101,102, such that a certainly technological difficulty in accurately positioning is thus presented, affecting the luminescence quality significantly, and

5. A whole set of LED array device must be abandoned if one of the LED is broken, not only wasting resource, but also increasing the expenditure cost.

Therefore, a second conventional LED array has been developed by the industry, as demonstrated in U.S. Pat. No. 4,916,464, entitled “LIGHT-EMITTING DIODE ARRAY PRINT HEAD HAVING NO BONDING WIRE CONNECTIONS”, disclosed by Oki Electric Industry Co., Ltd. Referring to FIGS. 3 and 4, this LED array essentially comprises a first connecting line 32, a second connecting line 34, and a third connecting line 36 buried at appropriate sites on a first substrate 31, and at least one LED array device 331-333 as well as at least one control IC 35 being prepared, wherein a plurality of LEDs 41 are provided in the LED array device 331, while each of the LEDs 41 have a corresponding first electrode 49 and second electrode 48. Subsequently, the LED array device 331 is placed on the surface of the substrate 31 directly between the first connecting line 32 and the second connecting line 34. A first mounting layer 42 and a second mounting layer 44 are used for electrically connecting the first electrode 49 of each LED 41 to the first connecting line 32, while electrically connecting the second electrode 48 to the second connecting line 34. Further, the control IC 35 may be also placed at the other side of the surface of the substrat 31 between the second connecting line 34 and the third connecting line 36, and a fourth mounting layer 45 as well as a third mounting layer 46 are used for electrically connecting the control IC 35 to the second connecting line 34 and the third connecting line 36. As such, the LED array may be finished, and a luminescence zone 38 may be, thus, formed by projecting light emitted from the LED 41 through the light-transmissive substrate 31, when a bias voltage is applied.

Notwithstanding, in the above conventional LED array, the number of wire-bondings may be reduced for effectively raising the yield rate of products, the structure thereof still exists problems as follows:

1. The cross-talk interference between two adjacent LEDs is induced, since it is still possible for the T-type light source emitted from the lateral face of each LED to project toward the surface of the adjacent LIED to radiate, thus increasing the difficulty for identifying exact luminescent location and further degrading the resolution quality of image;

2. It is incapable of observing or assuring that two adjacent LEDs array devices are located on an ideal predetermined circuit, since the LED array devices (331-333) are bonded on the first connecting line and the second connecting line directly, such that the technological difficulty in alignedly positioning still exists;

3. An spacing between arrays 339 still exists between any two of the LED array devices 331,332, such that a certainly technological difficulty in accurately positioning is thus presented, affecting the luminescence quality significantly, and

4. Due to the difficulty in alignedly positioning, a whole set of LED array device must be abandoned if one of the LED is broken, not only wasting resource, but also increasing the expenditure cost.

Therefore, how to propose a novel LED array, suitable for products with high density or high resolution, to overcome aforementioned problems is the key point of the present invention.

### SUMMARY OF THE INVENTION

Accordingly, it is a primary object of the present invention to provide a LED array capable of effectively solving aforementioned problems confronted by the conventional LED array.

it is a secondary object of the present invention to provide a LED array allowing each LED to be precisely positioned naturally by means of a plurality of regularly arranged light-outputting windows chiseled firstly into a circuit board, resulting in not only readily achieving the high quality requirement for products, but also effectively reducing the technological difficulty in precisely positioning between two adjacent LED array devices.

It is another object of the present invention to provide a LED array capable of placing each LED array device and control IC onto the circuit board to complete an electrical connection without repeated wire bonding processes, thus raising the yield rate of products and prolonging the service life of products effectively.

It is still another object of the present invention to provide a LED array capable of effectively blocking projecting light sources originated from LEDs in two adjacent light-outputting windows for effectively solve the cross-talk interference between LEDs, leading to not only increasing the identifiability for the luminescence location, but also raising the luminescent brightness.

It is yet another object of the present invention to provide a LED array having the circuit board being allowed to be made from various materials including light-transmissive and opaque materials to decrease constraints for manufacture.

### BRIEF DESCRIPTION OF DRAWINGS

FIG. 1 is a top view of a conventional LED array;

FIG. 2 is a schematic perspective view of the conventional structure shown in FIG. 1;

FIG. 3 is a schematic perspective view of another conventional LED array;

FIG. 4 is a cross section view of the conventional structure shown in FIG. 3;

FIG. 5 is an exploded structural view according to one preferred embodiment of the present invention;

FIG. 6 is an schematic assembled view of the LED array according to the present invention;

FIG. 7 is a cross-section view taken along II-II through the LED array according to the present invention;

FIG. 8 is a cross-section view taken along III-III through the LED array according to the present invention;

FIG. 9 is a structural cross-section view according to another embodiment of the present invention,

FIG. 10 is an exploded structural view according to still another embodiment of the present invention; and

FIG. 11 is an schematic assembled view according to the embodiment of the present invention shown in FIG. 10.

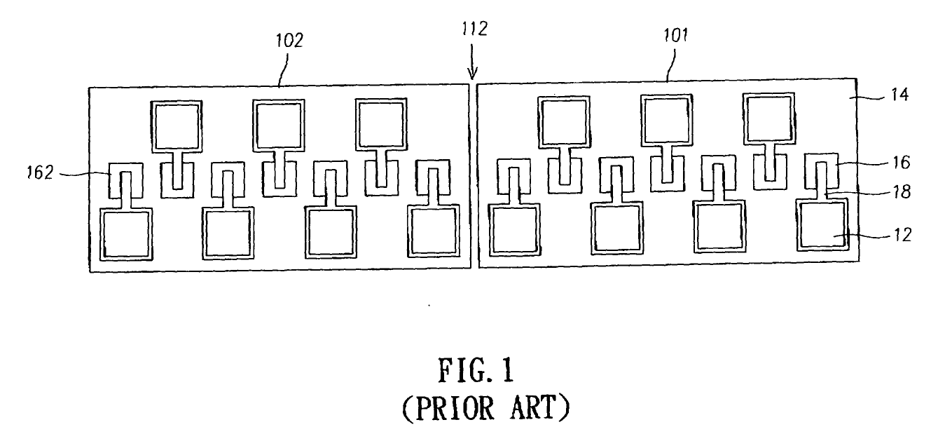

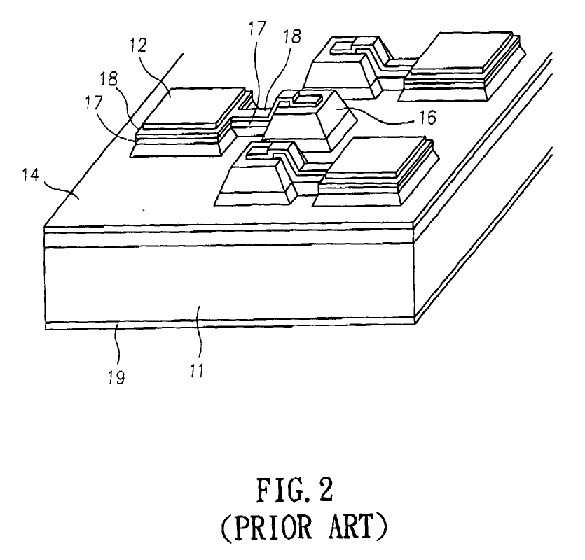

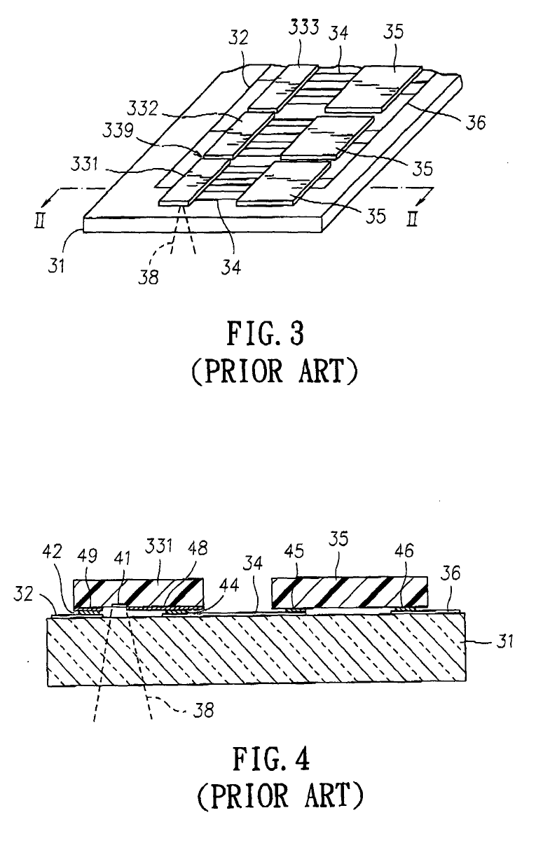

### DETAILED DESCRIPTION

The structural features and the effects to be achieved may further be understood and appreciated by reference to the presently preferred embodiments together with th detailed description.

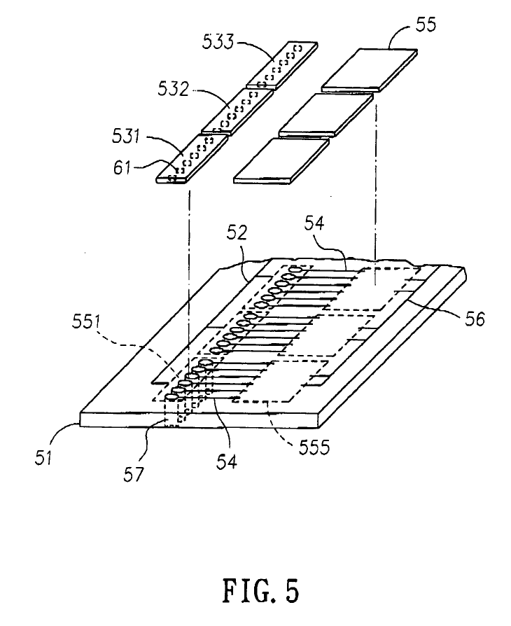

Firstly, referring to FIGS. 5 to 7, there are shown an exploded structural view, a schematic assembled view, and a cross-section view taken along II-II, respectively, of one preferred embodiment of a LED array of the present invention. As illustrated in these figures, a plurality of light-outputting windows 57 are firstly chiseled into a circuit board or substrate 51 (for example, PC board or semiconductor based substrate), by means of micro electro-mechanical technology, such as laser etching, chemical etching, semiconductor process, or manufacturing process for printed circuit board, as examples, in the present invention. A reflective layer 59 with light-reflecting function is formed on an inner wall of the light-outputting windows 57 by means of oblique deposition or vapor deposition, as examples, and a first connecting line 52, a second connecting line 54, and a third connecting line 56 may be buried at appropriate sites on the circuit board 51. Moreover, a plurality of LED array devices 531-533 and at least one control IC 55 are prepared, and a plurality of LEDs 61 are provided in the LED array device 531, each of the LEDs 61 having a corresponding first electrode 69 and second electrode 68. Subsequently, the LED array devices 531-533 are placed on the surface of the circuit board 51 directly, lying in the position illustrated as predetermined region 551 depicted in dashed line, between the first connecting line 52 and the second connecting line 54. The mounting or fusion welding technology, such as a first mounting layer 62 and a second mounting layer 64 (for instance, tin soldering paste substance or metal substance), are than used for electrically connecting the first electrode 69 of each LED 61 to the first connecting line 52, while electrically connecting the second electrode 68 to the second connecting, line 54. Further, the control IC 55 may be also placed at the other side of the surface of the circuit board 51, lying in the position illustrated as predetermined region 555 depicted in dashed line, between the second connecting line 54 and the third connecting line 56, and a fourth mounting layer 65 as well as a third mounting layer 66 are used for electrically connecting the control IC 55 to the second connecting line 54 and the third connecting line 56. As such, the LED array may be finished. A luminescence zone 58 may be, thus, formed by projecting light emitted from the LED 61 through the light-outputting windows 57 in the circuit board 51, when a bias voltage is applied.

Whether light-transmissive or opaque, various materials for the circuit board 51 are applicable in the structure of the present invention, not limited to the light-transmissive material as needed in the conventional structure, since the plurality of light-outputting windows 57, arranged transversely, linearly, and regularly, as well as allowing the projecting light source to pass through, are firstly chiseled into the circuit board 51 of the present invention. Further, the electrically connection between the electrodes and corresponding connecting lines may be accomplished by means of the mounting layers, resulting in a substantially decreased number of wire-bondings, and thus avoiding an imperfection of decreased yield rate of products caused by the wire-bonding step.

Furthermore, whether for the B-type light source emitted from a normal face, or for the T-type light source emitted from a lateral face, the projecting light source is always directed and constrained within the effective region of the light-outputting windows 57, resulting in significantly decreasing the cross-talk interference between two adjacent LEDs, and thus effectively raising the identifiability for exact location and the resolution quality for image, since the reflective layer 59 is provided on the inner wall of the light-outputting windows 57.

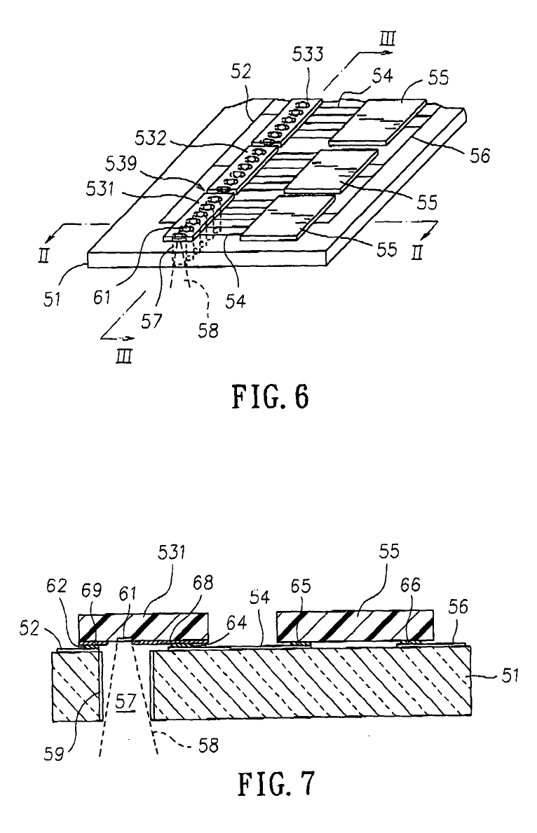

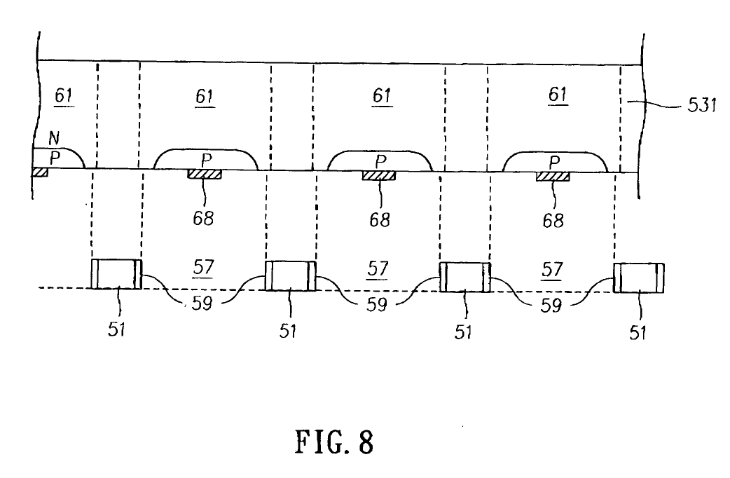

Moreover, referring to FIG. 8, there is shown an exploded structural view taken along III-III shown in FIG. 6 according to the embodiment of the present invention, As illustrated in this figure, the light-outputting windows 57 of the present invention have a better accuracy for transversely linear arrangement because they may be formed on the circuit board 51 accurately by laser etching, etc., such that the projecting light source could be emitted from each LED 61 through the corresponding light-outputting windows 57. In other words, although an array spacing 539 is still presented between any two of LED array devices 531, 532, it is still possible to observe or assure that two adjacent LED array devices 531-533 reside in an ideal predetermined position and an effectively raised luminescence quality is thus achieved, because the technology for aligning the LED array devices 531-533 is based on the light-outputting windows 57, rather than the LED array devices 531-533 in the conventional structure.

Further, if one of the LEDs 61 is broken in the manufacturing process, then only that cutting out the broken part and subsequently arranging valid LEDs based on the corresponding light-outputting windows 57 is required for the LED array device 531, rather than abandoning the whole of device as in the conventional structure, because the alignment for the present invention is based on the light-outputting windows 57. As such, not only effectively employing resource, but also decreasing manufacturing cost may be obtained.

Furthermore, a light-transmissive layer (not shown), such as colored filter plate, color conversion film, glass, or oxygen-containing resin, for example, may be further provided on the outer surface of the light-outputting windows 57. Thereby, not only the LEDs 61 could be protected, but also the object of changing the wavelength and color may be obtained.

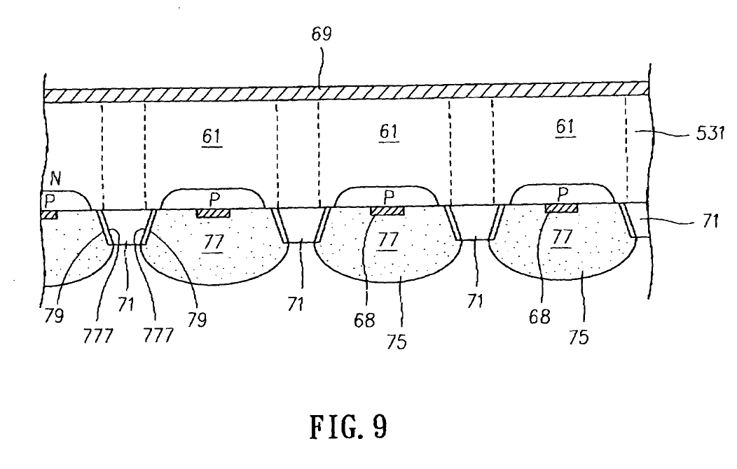

Additionally, referring to FIG. 9, there is shown a structural cross-section view of another embodiment of the present invention. As illustrated in this figure, a plurality of LEDs 61 are equally provided on the LED array device 531, while a first electrode 69 and a second electrode 68 are provided on each of the LEDs 61. A plurality of light-outputting windows 77, with respect to each of the LEDs 61, may be chiseled into the circuit board 71. In this embodiment, the light-outputting windows 77 are presented as a taper mode, and a reflective layer 79 with reflective function may be further provided on an inclined side 777 thereof. A sealing layer 75, containing a light-transmissive colloid, light-transmissive layer, oxygen-containing resin, or fluorescent body, as examples, therein is provided in the light-outputting window 77. Therefore, except for protecting the LEDs 61, the functions of condensing light, guiding light, and changing the wavelength and color of the projecting light source may be further obtained.

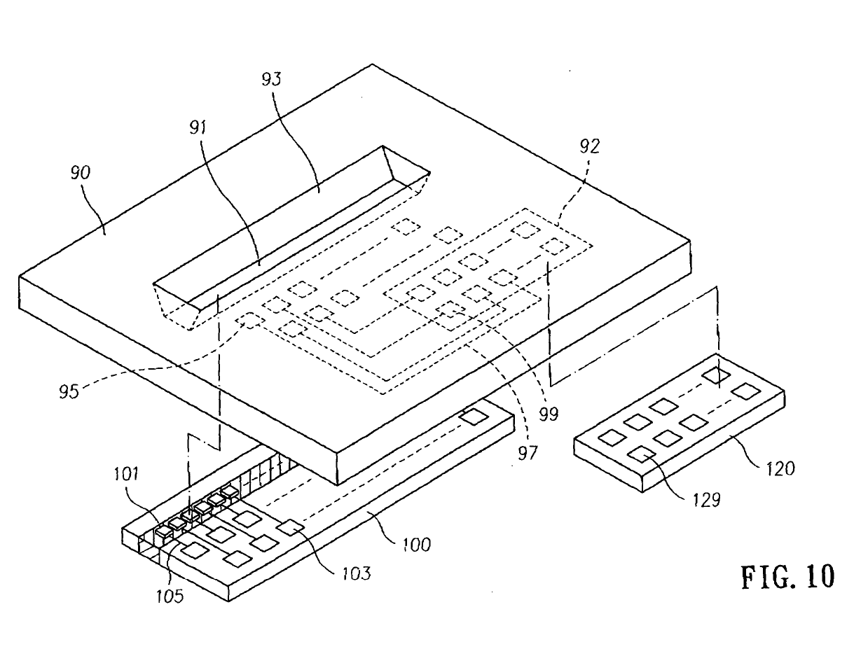

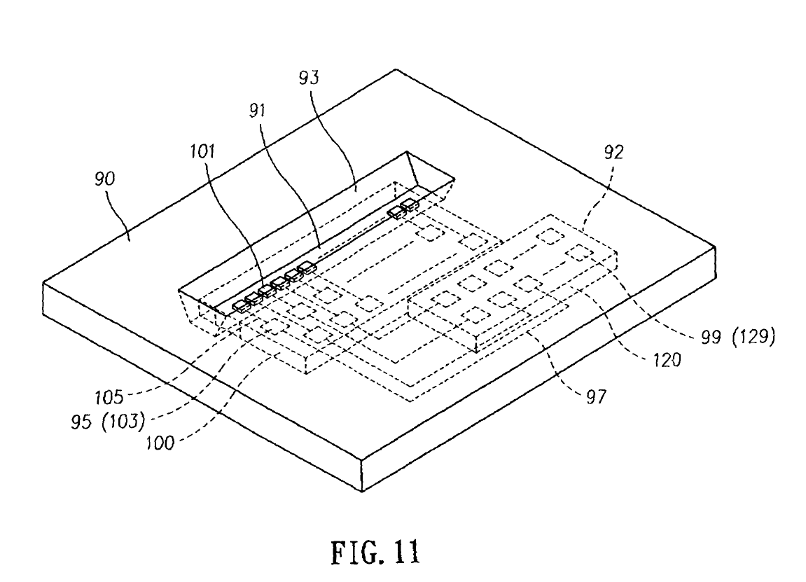

Finally, referring to FIGS. 10 and 11, there are shown an exploded structural view and a schematic assembled view of still another embodiment of the present invention. As illustrated in this figure, a light-outputting window 91, such as a bar-like V-shaped hole in this embodiment, for example, is chiseled into a circuit board 90 composed of a silicon substrate or other semiconductor substrates. A reflective layer 93 with a function of reflecting light or condensing may be equally provided on the side wall or inclined side wall of the light-outputting windows 91, while a plurality of first contacting regions for extension lines 95 may be buried in the silicon substrate 90 previously by means of micro electro-mechanical technology, such as semiconductor manufacturing process, for responding contacting points of the electrical connection in high-density devices. Each first contacting region for extension line 95 may be electrically connected to a first contacting region for control line 99, fixed within a predetermined region for control IC 92, via a control line 97.

A plurality of LEDs 101 are transversely and regularly arranged to form on a LED substrate (i.e., referred to a LED array device) 100, and each of the LEDs 101 may be electrically connected to a second contacting region for extension line 103 via an extension line 105. When the LED substrate 100 and the silicon substrate 90 are combined, the LED 101 could be aligned and placed in the light-outputting window 91, while the second contacting region for extension line 103 may be bonded and aligned with the first contacting region for extension line 95 naturally. Also, a control IC 120 may be connectedly provided within the predetermined region for control IC 92, and a plurality of second contacting regions for control lines 129 provided on the surface of the control IC 120 may be bonded and aligned with the corresponding first contacting regions for control lines 99 provided within the predetermined regions for control IC 92 of the silicon substrate. As such, by means of the second contacting region for extension line 103, the first contacting region for extension line 95, the control line 97, the first contacting region for control line 99, and the second contacting region for control line 129, the electrically connection between the LED 101 and the control IC 120 is thus finished, as illustrated in FIG. 11.

Although the control ICs (120) are presented on only one side of the circuit board (90) in all of the above embodiments, of course, the control ICs may be provided on both sides of the light-outputting windows (91) as well for responding a high-density LED array, while the extension lines (105) of any two of the LEDs (101) are electrically connected to the corresponding control ICs at different sides in an interlaced manner.

To sum up, the present invention is related to a LED array, particularly to a LED array with functions of accurately positioning and light-guiding provided by a plurality of light-outputting windows. Therefore, this application is filed in accordance with the patent law duly, since the present invention is truly an invention with novelty, advancement or non-obviousness, and availability by the industry, thus naturally satisfying the requirements of patentability. Your favorable consideration will be appreciated.

The foregoing description is merely one embodiment of present invention and not considered as restrictive. All equivalent variations and modifications in process, method, feature, and spirit in accordance with the appended claims may be made without in any way from the scope of the invention.

LIST OF REFERENCE SYMBOLS

| | |
|---|---|
| 101 | LED array device |
| 102 | LED array device |
| 11 | circuit board |
| 112 | spacing between arrays |
| 12 | wire-bonding region |
| 14 | active layer |
| 16 | current diffusion layer |
| 162 | current diffusion layer |
| 17 | insulative layer |
| 18 | second electrode |
| 19 | first electrode |
| 31 | substrate |
| 32 | first connecting line |
| 331 | LED array device |
| 332 | LED array device |
| 333 | LED array device |
| 339 | spacing between arrays |
| 34 | second connecting line |
| 35 | control IC |
| 36 | third connecting line |
| 38 | luminescence zone |
| 41 | LED |
| 42 | first mounting layer |
| 44 | second mounting layer |
| 45 | fourth mounting layer |
| 46 | third mounting layer |
| 48 | second electrode |
| 49 | first electrode |
| 51 | circuit board |
| 52 | first connecting line |
| 531 | LED array dcvice |
| 532 | LED array device |
| 533 | LED array device |
| 539 | spacing between arrays |
| 54 | second connecting line |
| 55 | control IC |
| 551 | predetermined region |
| 555 | predetermined region |
| 56 | third connecting line |
| 57 | light-outputting windows |
| 58 | luminescence zone |
| 59 | reflective layer |
| 61 | LED |
| 62 | first mounting layer |
| 64 | second mounting layer |
| 65 | fourth mounting layer |
| 66 | third mounting layer |
| 67 | sealing layer |
| 68 | second electrode |
| 69 | first electrode |
| 71 | circuit board |
| 75 | sealing layer |
| 77 | light-outputting window |
| 777 | inclined side |
| 79 | reflective layer |
| 90 | silicon substrate |
| 91 | light-outputting window |
| 92 | predetermined region for control IC |
| 93 | reflective layer |
| 95 | first contacting region for extension line |
| 97 | control line |
| 99 | first contacting region for control line |
| 100 | LED substrate |
| 101 | LED array device |
| 102 | LED array device |
| 103 | second contacting region for extension line |
| 105 | extension line |
| 120 | control IC |
| 129 | second contacting region for control line |

1. A light-emitting device (LED) array, comprising:
a circuit board, provided thereon with a plurality of second connecting lines and a plurality of light-outputting windows penetrating through said circuit board, each of said light-outputting windows corresponding to one of said second connecting lines;
at least one LED array device, having a plurality of LEDs provided thereon, a first electrode and a second electrode being both presented on each LED, while said LED array device allowed for connecting to the surface of said circuit board, resulting in each LED to be positioned in a location on the longitudinal extension line from said corresponding light-outputting window, and said second electrode thereof allowed for electrically connected to said second connecting line; and
at least one control IC, connectedly provided on the surface of said circuit board, and electrically connected to said corresponding second connecting line.

2. The LED array according to claim 1, wherein said circuit board further comprises at least one first connecting line, said first electrode of each LED electrically connected to said corresponding fist connecting line.

3. The LED array according to claim 1, wherein said circuit board further comprises at least one third connecting line, said third connecting line electrically connected to said control IC.

4. The LED array according to claim 1, wherein said light-outputting window includes a reflective layer therein.

5. The LED array according to claim 1, wherein said light-outputting window further includes a sealing layer therein.

6. The LED array according to claim 5, wherein the composition of said sealing layer is selected from the group consisting of light-transmissive colloid, light-transmissive layer, fluorescent body, oxygen-containing resin, or the combination thereof.

7. The LED array according to claim 1, wherein an outer surface of said light-outputting window further comprises a light-transmissive layer covering thereon.

8. The LED array according to claim 7, wherein the composition of said light-transmissive layer is selected from the group consisting of colored filter plate, color conversion film, glass, or oxygen-containing resin, or the combination thereof.

9. The LED array according to claim 1, wherein said light-outputting window is presented as a taper mode.

10. The LED array according to claim 1, wherein the composition of said circuit board is selected from the group consisting of PC board, silicon substrate, semiconductor based substrate, light-transmissive material, opaque material, or the combination thereof.

11. A light-emitting device (LED) array, comprising:
a circuit board, provided thereon with a plurality of second connecting lines, at least one third connecting line, and a plurality of taper-shaped light-outputting windows penetrating through said circuit board and presented as a taper mode, each of said taper-shaped light-outputting windows corresponding to one of said second connecting lines;
at least one LED array device, having a plurality of LEDs provided thereon, a first electrode and a second electrode being both presented on each LED, while said LED array device allowed for connecting to the surface of said circuit board, resulting in each LED to be positioned in a location on the longitudinal extension line from said corresponding taper-shaped light-outputting window, and said second electrode thereof allowed for electrically connected to said second connecting line; and
at least one control IC, connectedly provided on the surface of said circuit board, and electrically connected to said corresponding second connecting line and third connecting line, respectively.

12. The LED array according to claim 11, wherein said circuit board further comprises at least one first connecting line, said first electrode of each LED electrically connected to said corresponding first connecting line.

13. The LED array according to claim 11, wherein said taper-shaped light-outputting window includes a reflective layer therein.

14. The LED array according to Claim 11, wherein said light-outputting window further includes a sealing layer therein, and the composition of said sealing layer is selected from the group consisting of light-transmissive colloid, light-transmissive layer, fluorescent body, oxygen-containing resin, or the combination thereof.

15. The LED array according to claim 11, wherein an outer surface of said taper-shaped light-outputting window further comprises a light-transmissive layer covering thereon, and the composition of said light-transmissive layer is selected from the group consisting of colored filter plate, color conversion film, glass, oxygen-containing resin, or the combination thereof.

16. The LED array according to claim 11, wherein the composition of said circuit board is selected from the group consisting of PC board, silicon substrate, semiconductor based substrate, light-transmissive material, opaque material, or the combination thereof.

17. A light-emitting device (LED) array, comprising:
a circuit board, provided thereon with at least one first connecting line, second connecting line, third connecting line, and light-outputting window penetrating through said circuit board, wherein said light-outputting window is situated between said connecting line and said second connecting line;
at least one LED array device, having a plurality of LEDs provided thereon, a first electrode and a second electrode being both presented on each LED, while said LED array device allowed for connecting to the surface of said circuit board, resulting in each LED to be positioned in a location on the longitudinal extension line from said corresponding light-outputting window, and said first electrode thereof allowed for electrically connected to said corresponding first connecting line while said second electrode thereof allowed for electrically connected to said corresponding second connecting line; and
at least one control IC, connectedly provided on the surface of said circuit board between said second connecting line and said third connecting line, and electrically connected to said corresponding second connecting line and third connecting line, respectively.

18. The LED array according to Claim 16, wherein said light-outputting window is presented as a taper mode.

19. The LED array according to claim 16, wherein said light-outputting window further provides a reflective layer therein.

20. The LED array according to claim 16, wherein said light-outputting window further includes a sealing layer therein.

21. A light-emitting device (LED) array, comprising:
a circuit board having at least one hole chiseled therethrough, a plurality of first contacting regions for extension lines being buried in said circuit board, each of said first contacting regions for extension lines being electrically connected to a corresponding first contacting region for control line by means of a control line, said first contacting region for control line being situated within a predetermined region for control IC on said circuit board;
at least one LED array device having a plurality of LEDs, each of said LEDs being electrically connected to a corresponding second contacting region for extension line by means of an extension line, wherein if said LED array device is connectedly provided on the surface of said circuit board, said second contacting region for extension line of said LED array device is electrically connected to said first contacting region for extension line of said circuit board, while said plurality of LEDs are aligned and resided inside said hole; and
at least one control IC provided therein with a plurality of second contacting regions for control lines, said control IC being connectedly provided within said predetermined region for control IC on said circuit board, resulting in said second contacting regions for control lines of said control IC being electrically connected to said first contacting regions for control lines of said circuit board naturally.

22. The LED array according to claim 21, wherein said hole is presented as a V-shaped mode.

23. The LED array according to claim 21, wherein said hole is presented as a bar-shaped mode.

24. The LED array according to claim 21, wherein the side of said hole includes at least one reflective layer thereon.

25. The LED array according to claim 21, wherein said circuit board is selected from the group consisting of PC board, silicon substrate, semiconductor based substrate, or the combination thereof.

26. The LED array according to claim 24, wherein said light-outputting window her includes a sealing layer therein, and the composition of said sealing layer is selected from the group consisting of light-transmissive colloid, light-transmissive layer, fluorescent body, oxygen-containing resin, colored filter plate, color conversion film, glass, or the combination thereof.
